(19) United States
(12) Patent Application Publication
(10) Pub. No.: US 2023/0032804 A1
(43) Pub. Date: Feb. 2, 2023

(54) Photostability Prediction Method of Organic Material Using La-Dart-MS

(71) Applicant: LG Chem, Ltd., Seoul (KR)

(72) Inventors: Hyun Sik You, Daejeon (KR); Yongjin Bae, Daejeon (KR); Young Hee Lim, Daejeon (KR); Yeu Young Youn, Daejeon (KR); Hye Mi Oh, Daejeon (KR); Dong Mok Shin, Daejeon (KR)

(73) Assignee: LG Chem, Ltd., Seoul (KR)

(21) Appl. No.: 17/789,400

(22) PCT Filed: Oct. 19, 2021
(86) PCT No.: PCT/KR2021/014541

§ 371 Date: Jun. 27, 2022

(30) Foreign Application Priority Data
Oct. 19, 2020 (KR) 10-2020-0135280
Oct. 19, 2021 (KR) 10-2021-0138930

(51) Int. Cl. G01N 21/63; G01N 21/39

(52) U.S. Cl. CPC G01N 21/63; G01N 21/39; G01N 2021/1791

(57) ABSTRACT

The present disclosure relates to a method for predicting photostability of an organic material within a short time using LA-DART-MS, the method including the steps of: irradiating a specimen containing an organic material with a laser beam; obtaining a mass spectrum of components desorbed and ionized from the specimen; and calculating a degradation yield of the mathematical expression 1 according to the present disclosure from the mass spectrum. The method for predicting photostability of an organic material according to the present disclosure as described above can predict photostability within seconds to minutes, which is a remarkably short time, as compared with a conventional method for measuring photostability of an organic material.

### CROSS-REFERENCE TO RELATED APPLICATIONS

The present application is a national stage entry under 35 U.S.C. §371 of International Application No. PCT/KR2021/014541 filed on Oct. 19, 2021, which claims priority from Korean Patent Applications No. 10-2020-0135280 filed on Oct. 19, 2020, and No. 10-2021-0138930 filed on Oct. 19, 2021, all the disclosures of which are incorporated herein by reference.

### TECHNICAL FIELD

The present disclosure relates to a method for predicting photostability of an organic material within a short time using LA-DART-MS.

### BACKGROUND ART

The photostability of an organic material is related to the degradation of the organic material by a light source, is an important factor that influences the long-life operation of the light emitting system when the organic material is used in the light emitting system, which is a physical property that should be considered importantly in applying to devices such as displays.

When the photostability of an organic material having light emitting properties is deteriorated, the phenomenon of photobleaching occurs. Photobleaching refers to a phenomenon in which, after an organic material is excited via external energy, it does not exhibit normal emission but loses its emission properties due to the formation of new bonds in the organic material, the structural degradation, the reaction with other materials, and the like. If the photostability of the organic material is deteriorated, degradation products or insoluble particles may be formed by a light source. Because degradation products can have absorption properties similar to those of organic materials, it interferes with the absorption of organic materials, and the insoluble particles induce scattering of the light source, resulting in photobleaching.

The evaluation of photostability is generally performed by measuring changes in absorption or emission spectrum after long exposure to an evaluation light source similar to the light source used for products to which organic materials are applied, or by measuring the reduction rate of the absorption or emission photons. Thereafter, the degree of degradation of the material, the structure of the degradation product and the like are analyzed through offline GC, LC/MS analysis and the like. However, such a process for measuring photostability and confirming the degradation products has a drawback in that the physical properties of the material are predicted due to long irradiation time (hundreds to thousands of hours) and offline analysis for the evaluation light source, and it takes a long time to confirm the degradation products that cause the deterioration of physical properties.

Therefore, in order to develop an organic material having excellent physical properties, there is a need to develop an analytical method capable of predicting the photostability within a short time.

### DETAILED DESCRIPTION OF THE INVENTION

### Technical Problem

It is one object of the present disclosure to provide an analytical method capable of predicting the photostability of an organic material within a short time using LA-DART-MS.

### Technical Solution

In order to achieve the above object, according to the present disclosure, there is provided a method for predicting photostability of an organic material as follows:
A method for predicting photostability of an organic material using LA-DART-MS, comprising the steps of:
irradiating a specimen containing an organic material with a laser beam (step 1);
obtaining a mass spectrum of components desorbed and ionized from the specimen (step 2); and
calculating a degradation yield of the following mathematical expression 1 from the mass spectrum (step 3):

### Mathematical Expression 1

Degradation yield = (Sum of peak intensities of fragment ions) / (Sum of peak intensities of (molecular ions + fragment ions))

The present disclosure is directed to evaluating photostability among the physical properties of organic materials, and the organic material of interest is not particularly limited. Particularly, the photostability is a physical property that should be considered importantly in a light emitting material, and from this viewpoint, the organic material of the present disclosure includes an organic light emitting material having light emitting properties, and its photostability is predicted.

The present disclosure predicts photostability of an organic material by using LA-DART-MS instead of using an evaluation light source for the evaluation of the photostability of conventional organic materials, and the present disclosure is characterized in that components desorbed from an organic material by laser beam irradiation is ionized with ion sources to obtain a mass spectrum, and then the photostability is predicted through spectral analysis.

Although not theoretically limited, irradiation with an evaluation light source and irradiation with a laser beam are similar in the degradation of organic materials, and therefore, the photostability of organic materials can be predicted within a shorter time from the correlation thereof.

In particular, in the present disclosure, LA-DART-MS is used, and the photostability can be predicted within a shorter time compared to evaluating photostability with a conventional evaluation light source. In order to evaluate photostability with a conventional evaluation light source as described later, the organic material must be exposed to the evaluation light source for hundreds to thousands of hours. However, when LA-DART-MS is used as in the present disclosure, the mass spectrum of the degraded products can be obtained directly, which can be analyzed to predict the photostability, and as a result, there is an advantage in that the photostability of the organic material can be predicted within a few seconds to a few minutes.

The term “LA-DART-MS (Laser ablation-direct analysis in real time-mass spectrometry)” as used herein refers to an analytical method that performs the molecular weight and structure analysis of a material by irradiating a specimen with a laser beam to desorb the analyte, and then ionizing the desorbed analyte with a heated metastable helium gas beam from the DART ion source and reactive ions generated therefrom. The system for the LA-DART-MS is schematically shown in FIG. 1. Now, the present disclosure will be described in detail step by step with reference to FIG. 1.

### Step 1

Step 1 of the present disclosure is a step of irradiating a specimen containing an organic material with a laser beam, through which the organic material is degraded in the same manner as in the case where an organic substance is irradiated to an evaluation light source.

First, a system for LA-DART-MS will be described in relation to the step 1. As shown in FIG. 1, the LA-DART-MS system 1 includes a DART ionization unit 10, a mass spectrometer 20, a specimen mounting unit 30, and a laser unit 40.

In the DART ionization unit 10, a laser beam is irradiated from the laser unit 40, the analyte desorbed from the specimen 2 mounted on the specimen mounting unit 30 is ionized using a helium beam of the DART ionization unit 10 and reactive ions generated therefrom. Specifically, a helium beam is emitted from an outlet 11 of the DART ionization unit 10 to ionize the analyte desorbed from a specimen 2 mounted on the specimen mounting unit 30.

The mass spectrometer 20 receives the ionized analyte and performs the molecular weight and structure analysis of the ionized analyte. The specimen mounting unit 30 is located between an outlet 11 of the DART ionization unit 10 and an inlet 21 of the mass spectrometer 20. Since the analyte desorbed from the specimen 2 mounted on the specimen mounting unit 30 flows into the inlet of the mass spectrometer 20, the specimen mounting unit 30 is located at a place lower than the path between the outlet 11 of the DART ionization unit 10 and the inlet 21 of the mass spectrometer 20. The inlet 21 of the mass spectrometer 20 may be a hole or a protruding pipe that is formed in the mass spectrometer 20 in order for the analyte outside the mass spectrometer 20 to flow into the internal space of the mass spectrometer 20 for analysis. For example, the inlet 21 of the mass spectrometer 20 may be an orifice or a transfer tube protruding and extending from the orifice.

The laser unit 40 irradiates the specimen 2 with a laser beam to desorb the analyte from the specimen. Further, while the analyzer confirms the mass spectrum in real time, the relative position of the laser unit 40 or the irradiation angle and power of the laser beam can be adjusted so that the ion peak intensity of the analyte derived from the specimen 2 is maximized.

Further, the LA-DART-MS system 1 may include an interface unit 100 located in the path between the outlet 11 of the DART ionization unit 10 and the inlet 21 of the mass spectrometer 20. The interface unit 100 has a tubular body which is opened in both end parts. One end of both end parts of the interface unit 100 may overlap or be disposed adjacent to the distal end of the outlet 11 of the DART ionization unit 10. And, the other end part is fitted into the outer surface of the inlet 21 of the mass spectrometer 20, or may make contact with the inlet 21 of the mass spectrometer 20 or may be connected to the inlet 21 so as to be spaced apart by a predetermined distance (about 2 mm). When the interface unit 100 is used, it is possible to effectively collect the components desorbed and ionized by the laser and increase the transmission toward the mass spectrometer, thereby improving detection sensitivity and signal stability.

When the specimen 2 mounted on the specimen mounting unit 30 is irradiated with a laser beam using the LA-DART-MS system as described above, components that are desorbed from the specimen containing the organic material are generated, and ionized by using a helium beam from the DART ionization unit 10 and reactive ions generated therefrom. A helium beam is emitted from the outlet 11 of the DART ionization unit 10 to ionize the analyte desorbed from the specimen 2 mounted on the specimen mounting unit 30, and the ionized analyte flows into the mass spectrometer 20, and mass spectra obtained from analytes can be analyzed as in step 2 described later.

The laser beam can be appropriately adjusted depending on the organic material.

Specifically, the laser may be a continuous wave (CW) or a pulsed laser.

Further, the power of the laser beam may be 0.001 mW to 10 W. When the power of the laser beam is less than 0.001 mW, the power of the laser beam is weak, so that the components desorbed from the specimen containing the organic material are generated in a small amount, which may make it difficult to analyze the mass spectrum. When the power of the laser beam is greater than 10 W, the power of the laser beam is so strong that it can damage or severely destroy specimens containing organic materials, which may make it difficult to analyze the mass spectrum. Preferably, the power of the laser beam may be 0.001 mW to 1 W.

Further, the wavelength of the laser beam may be 200 nm to 3000 nm. The above is a range analyzed as a range of the absorption wavelength of a general organic material, and can be appropriately adjusted in consideration of the absorption wavelength of the organic material to be analyzed.

Further, the irradiation time of the laser beam may be set from the irradiation time of the laser beam to the time when a specific peak is no longer observed in a mass spectrum described later. Preferably, the time sufficient to obtain an effective mass spectrum is 30 minutes or less, more preferably 10 minutes or less. In particular, the irradiation time of the laser beam is significantly shorter than the irradiation time of several hundreds to several thousand hours, which is the irradiation time required for measuring the photostability with a conventional evaluation light source, through which it is possible to predict the photostability within a quick time.

### Step 2

Step 2 of the present disclosure is a step of obtaining a mass spectrum of components desorbed and ionized from the specimen by the step 1.

When a specimen containing an organic material is irradiated with a laser beam according to the step 1, the organic material is desorbed from the specimen, and a part of the organic material is also degraded to generate a degradation product. Since the degree of degradation of such an organic material is related to the photostability, the mass spectrum in the present disclosure is analyzed in order to confirm the degree of degradation of the organic material.

On the other hand, for the mass spectrum analysis, in order to directly detect components desorbed and ionized by the ion source during the laser beam irradiation in step 1, as described above, the specimen containing the organic material is located between the outlet 11 of the DART ionization unit 10 and the inlet 21 of the mass spectrometer 20, more preferably, the specimen mounting unit 30 is located at a place lower than the path between the outlet 11 of the DART ionization unit 10 and the inlet 21 of the mass spectrometer 20.

Moreover, a mass spectrum can be directly obtained through the step 2, and the mass spectrum includes information on degradation products of organic materials. Thus, there is an advantage in that the analysis of degradation products, for example, the molecular weight and structural analysis can also be performed quickly.

When photostability is evaluated with a conventional evaluation light source, not only the organic material must be exposed to the evaluation light source for a long time, but also it took a long time to confirm the molecular weight and structure of the degradation products because it is necessary to go through the sample pretreatment process again and perform GC or LC/MS analysis to confirm the molecular weight and structure. However, through step 2 of the present disclosure, the mass spectrum of the components desorbed and ionized from the specimen can be directly obtained, and the sample pretreatment process and the like are not required, whereby it is possible to analyze the degradation products of organic materials within a significantly shorter time as compared with a conventional one.

### Step 3

Step 3 of the present disclosure is a step of calculating the degradation yield of the mathematical expression 1 from the mass spectrum obtained in step 2.

Just as the organic material is irradiated to the evaluation light source, it is similarly degraded by irradiating the organic material with a laser beam, and therefore, the degree of this degradation can be analyzed to predict the photostability of the organic material.

The mathematical expression 1 calculates a degradation yield in order to analyze it, and mathematically expressed as follows. In the following, “I” means the intensity of each peak. In the peak detected in the mass spectrum, a molecular ion peak of an undegraded organic material and a peak of fragment ions generated by degrading an organic material exist, and thus, the degradation yield can be calculated through the mathematical expression 1.

Degradation yield = ∑ I (fragment ions) / ∑ I (parent + fragment ions)

The lower the degradation yield obtained according to the above, the lower the degree of degradation of the organic material by the laser beam, which can be predicted that the photostability of the organic material is excellent. On the contrary, the higher the degradation yield, the greater the degree of degradation, which can be predicted that the photostability of the organic material is deteriorated.

By applying the above, the relative photostability between organic materials can be evaluated. For example, if the photostability is to be compared with that of a specific organic material, the degradation yields of the specific organic material and the other organic material can be measured according to the steps 1 to 3, and compared with each other to compare the photostability.

### Step 4

The present disclosure may further include a step of linearly regression-analyzing the photostability data (X) of the organic material and the degradation yield (Y) obtained in step 3 to derive a prediction expression of the photostability of the organic material, if necessary.

When the degradation yield of each of the plurality of organic materials is obtained by the above-mentioned steps 1 to 3, a relational expression between the degradation yield (Y) and the photostability data (X) of the plurality of organic materials can be derived therefrom through regression analysis, the degradation yields of other organic materials can be obtained from this relational expression to predict the photostability thereof.

On the other hand, the photostability data of the plurality of organic materials is obtained by exposing the organic material to an evaluation light source for a long time, then measuring the change in absorption or emission spectrum, or by measuring the reduction rate of the absorption or emission photons. Thereafter, the degree of degradation of the material and the structure of the degradation product can be analyzed through offline GC and LC/MS analysis.

As in Examples described later, the photostability data of the plurality of organic light emitting materials in the present disclosure is obtained by exposing the organic light emitting material to an evaluation light source for 500 hours, and measuring the number of photons in the absorption or emission wavelength region with a luminance meter. It could be confirmed that this correlates with the degradation yield measured according to the present disclosure.

### Advantageous Effects

As described above, the method for predicting photostability of an organic material according to the present disclosure can predict the photostability within a shorter time than the conventional method for measuring the photostability of an organic material.

### BRIEF DESCRIPTION OF THE DRAWING

FIG. 1 schematically shows an apparatus used for predicting photostability in the present disclosure;

FIG. 2 shows the mass spectrum obtained for organic light emitting material 1 in Example of the present disclosure; and

FIG. 3 graphically shows the results of Examples of the present disclosure.

### DETAILED DESCRIPTION OF THE EMBODIMENTS

Hereinafter, embodiments of the present disclosure will be described in more detail by way of examples. However, the following examples are only provided for illustrative purposes, and the contents of the present disclosure are not limited by these examples.

### Example

### Step 1) Experimental Material

The following five compounds were used as experimental materials, and the substituents of each compound are shown in Table 1 below.

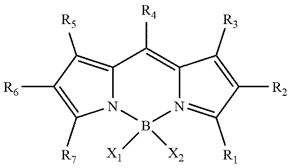

Table 1

| | |
|---|---|
| Organic light emitting material 1 | R₁, R₃, R₅, R₇ = methyl / R₂, R₆ = ethyl formate / R₄ = phenyl / X₁, X₂ = F |
| Organic light emitting material 2 | R₁, R₃, R₅, R₇ = methyl / R₂, R₆ = CN / R₄ = phenyl / X₁, X₂ = F |
| Organic light emitting material 3 | R₁, R₃, R₇ = cycloheptyl / R₅ = cyclohexyl / R₂ = CN / R₆ = H / R₄ = phenyl / X₁, X₂ = F |
| Organic light emitting material 4 | R₁, R₃, R₅, R₇ = cyclohexyl / R₂ = CN / R₆ = H / R₄ = phenyl / X₁, X₂ = F |
| Organic light emitting material 5 | R₁, R₃, R₅, R₇ = cyclohexyl / R₂ = CN / R₆ = H / R₄ = phenyl / X₁, X₂ = CN |

### Step 2) Preparation of Specimen

For each of the organic light emitting materials 1 to 5, 0.5 mg of the organic light emitting material in powder form was loaded onto an aluminum plate, and then crimped using a pellet tool to prepare a specimen having a diameter of about 3 mm.

### Step 3) Experimental Instrument

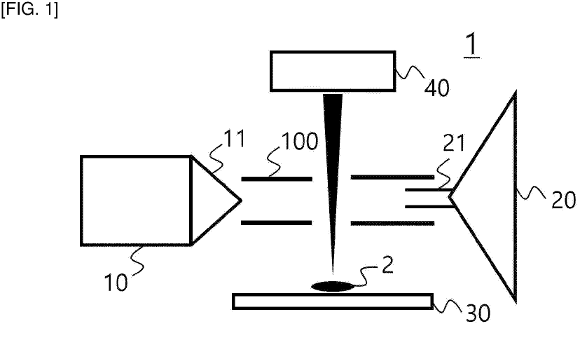

The LA-DART-MS system as shown in FIG. 1 was used. Specifically, the LA-DART-MS system 1 includes a DART ionization unit 10, a mass spectrometer 20, a specimen mounting unit 30, and a laser unit 40. A laser beam was set to irradiate to a specimen 2 of the specimen mounting unit 30 from the laser unit 40, and the specimen mounting unit 30 was located below the path between the outlet 11 of the DART ionization unit 10 and the inlet 21 of the mass spectrometer 20.

### Step 4) Laser Beam Irradiation and Mass Spectrum Measurement

Each of the prepared specimens was irradiated with a laser, and the laser, ion source temperature, and mass spectrum measurement conditions were as follows.
Laser power: 180 mW, continuous wave, blue laser beam (405 nm)
Ion source temperature: 400° C.
Mass spectrometer: positive mode (ionization mode), FTMS (analyzer), 240,000 (resolution)

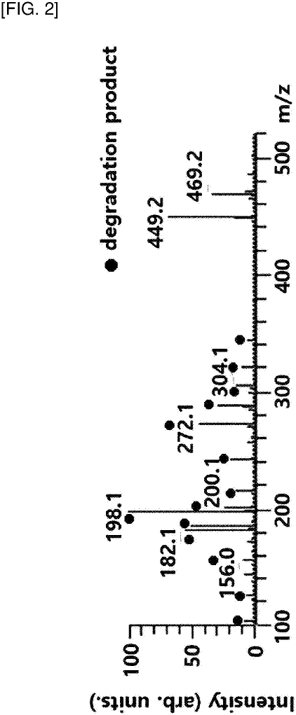

After laser irradiation for each specimen, the intensities of parent ions and fragment ions were calculated based on the mass spectrum obtained for 1 minute, and then the degradation yield was measured according to the mathematical expression 1. Three mass spectra were obtained for each specimen, and the average value and error were calculated. Typically, the mass spectrum of the organic light emitting material 1 is shown in FIG. 2.

### Step 5) Measurement of Photostability for Evaluation Light Source

The photostability was measured by a method in which an organic light emitting material was exposed to an evaluation light source for a long time. Specifically, each of the organic light emitting materials 1 to 5 was exposed to an evaluation light source (400 to 450 nm) for 500 hours, and the number of photons in the absorption or emission wavelength region was measured with a luminance meter. At this time, a ratio that decreases with time compared to the initial value was obtained as the photostability data.

### Step 6) Experimental Results

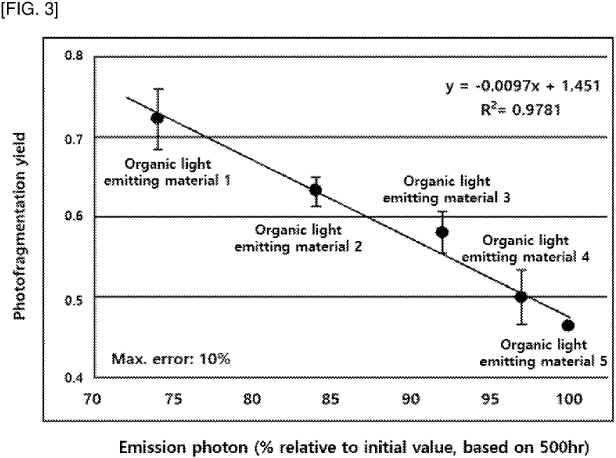

The experimental results are shown in FIG. 3. In FIG. 3, the x-axis is photostability data for the evaluation light source obtained in step 5, and the y-axis means the degradation yield obtained in step 4.

As shown in FIG. 3, it can be confirmed that the higher the degradation yield obtained in step 4 according to the present disclosure, the lower the photostability, and conversely, the lower the degradation yield, the better the photostability.

Further, when the graph of FIG. 3 is linearly regression-analyzed, the relational expression in the right upper end of FIG. 3 can be obtained, and after obtaining the same degradation yield as in step 4 for other Organic light emitting materials, the photostability can be estimated by substituting for the above relational expression.

Accordingly, the photostability of the organic light emitting material can be predicted within a significantly shorter time (1 minute) than 500 hours, which is the measurement time of light resistance according to the evaluation light source of the organic light emitting material.

### EXPLANATION OF SYMBOLS

1: LA-DART-MS system
2: specimen
10: DART ionization unit
11: outlet of DART ionization unit
20: mass spectrometer
21: inlet of mass spectrometer
30: specimen mounting unit
40: laser unit
100: interface unit

1. A method for predicting photostability of an organic material using laser ablation-direct analysis in real time-mass spectrometry (LA-DART-MS), comprising the steps of:
irradiating a specimen containing an organic material with a laser beam and ionizing with a helium beam from an ablation-direct analysis in real time (DART) ionization unit to obtain components desorbed and ionized from the specimen (step 1);
obtaining a mass spectrum of the components desorbed and ionized from the specimen by a mass spectrometer (step 2); and
calculating a degradation yield using the following Mathematical Expression 1 from the mass spectrum (step 3):
[Mathematical Expression 1]
Degradation yield = (Sum of peak intensities of fragment ions) / (Sum of peak intensities of (molecular ions + fragment ions)).

2. The prediction method according to claim 1, wherein the laser beam is a continuous wave (CW) or a pulsed laser.

3. The prediction method according to claim 1, wherein a power of the laser beam is 0.001 mW to 10 W.

4. The prediction method according to claim 1, wherein a wavelength of the laser beam is 200 nm to 3000 nm.

5. The prediction method according to claim 1, wherein an irradiation time of the laser beam is 30 minutes or less.

6. The prediction method according to claim 1, wherein
an irradiation time of the laser beam is 10 minutes or less.

7. The prediction method according to claim 1,
which further comprises linearly regression-analyzing photostability data (X) of the organic material and the degradation yield (Y) obtained in step 3 to derive a prediction expression of the photostability of the organic material (step 4).

8. The prediction method according to claim 1,
wherein the specimen containing the organic material is located between an outlet of the DART ionization unit and an inlet of the mass spectrometer.
